(19) United States
(12) Patent Application Publication
(10) Pub. No.: US 2014/0071678 A1
(43) Pub. Date: Mar. 13, 2014

(54) LED LIGHT BULB STRUCTURE

(71) Applicant: POWER DIGITAL DELIGHT CO., LTD., New Taipei City (TW)

(72) Inventors: CHIEN-YUAN CHEN, Taipei City (TW); YING-TE CHUANG, Kaohsiung City (TW)

(73) Assignee: POWER DIGITAL DELIGHT CO., LTD., New Taipei City (TW)

(21) Appl. No.: 13/761,329

(22) Filed: Feb. 7, 2013

(30) Foreign Application Priority Data
Sep. 7, 2012 (TW) 101217372

(51) Int. Cl. F21V 21/00

(52) U.S. Cl. CPC F21V 21/00
USPC 362/249.02

(57) ABSTRACT

A LED light bulb structure has a base body, a control circuit board, a housing, at least a LED light source and a cover body. The base body is connected to the housing to form a containing space for disposing the control circuit board. The housing is disposed with a mounting portion that is inclined toward the housing to dispose the LED light source. Since the mounting potion is inclined, the illumination range of light beam of the LED light source is increased to provide wider illumination range without affecting the brightness of the LED light bulb structure, wherein the housing is integrally formed and disposed with a plurality of gutters at its outer surface to enhance heat dissipation effect, and integrated formation can also simplify the manufacture process and save the assembly time.

### CROSS-REFERENCE TO RELATED APPLICATIONS

This non-provisional application claims priority under 35 U.S.C. §119(a) on Patent Application No(s). 101217372 filed in Taiwan, R.O.C. on Sep. 7, 2012, the entire contents of which are hereby incorporated by reference.

### BACKGROUND OF THE INVENTION

1. Field of the Invention

The invention relates to a LED (light emitting diode) lamp, and more particularly to a LED light bulb structure capable of enhancing the illumination range.

2. Description of the Related Art

Earlier illumination lamps are principally incandescent lamps and mercury lamps. Although these incandescent lamps and mercury lamps have features of low costs and long service life, the earlier illumination lamps are gradually replaced with LED lamps that are widely applied in illumination recently due to their defects of insufficient light condensing, huge lamp volume, weak color render index, disposal pollution and worse heat dissipation. The LED lamp has better light emitting efficiency and color render index than the conventional incandescent lamps and mercury lamps and has smaller volume. Therefore, the LED lamp is currently a popular light emitting element. Lamps made of LEDs are diversity. For example, the volume of flat-shaped LED lights can be regulated in accordance with the requirements. Moreover, LED can be applied as downlights placed in a light steel frame and LED light bulb can fit traditional assembly holes.

The range of irradiating light beam from the light bulb is usually narrow since the volumes and spaces for disposing LED lamps are restricted.

With reference to FIG. 1 for a conventional LED light bulb 1 including a base body 10, a control circuit board (not shown in the figure), a bearing seat 11, a plurality of LED lamps 12 and a lamp housing 13. The base body 10 has a containing space 101 for placing the control circuit board. The bearing seat 11 has a mounting surface 111, and the mounting surface 111 is located at a top of the bearing seat 11 to dispose the LED lamps 12. The lamp housing 13 covers the mounting surface 111 and seals the LED lamps 12. The LED lamps 12 are electrically connected to the control circuit board. Since the LED lamps 12 are mounted on the mounting surface 111 which is planar, the light emitting path of the LED lamps 12 is vertical and upward as shown in FIG. 1. The design may cause narrow illumination range of the conventional LED light bulb 1 to reduce the practicality. While illuminating for a larger area, number of the LED light bulb must be increased.

To increase the practicality and illumination range of the LED light bulb, the inventor(s) designs a LED light bulb structure having an inclined mounting portion to increase the illumination range of light beam from LED lamps.

### SUMMARY OF THE INVENTION

Therefore, it is a primary objective of the present invention to provide a LED light bulb structure comprising at least an inclined mounting portion on a housing to dispose at least a LED light source such that the illumination range of light beam emitted by the LED light bulb structure after electrifying. By comparing with a conventional lamp, it has a greater illumination range without affecting the light emitting intensity of the LED light source.

A second objective of the invention is to provide a LED light bulb structure. Its housing for disposing a LED light source is integrally formed and disposed with a plurality of gutters to smoothly exhaust heat energy generated by the LED light source, thereby effectively simplifying the manufacture process and achieving the effect of heat dissipation. In addition, by incorporating with a plurality of piercing holes on a cover body, ventilation can be provided to improve heat dissipation efficiency.

To achieve the foregoing objectives, the LED light bulb structure of the invention has a base body, a control circuit board, a housing, at least a LED light source and a cover body. The base body is disposed with an electrical connection portion and connected to a side of the housing to form a containing space for disposing the control circuit board. The LED light source is disposed to the housing and electrically connected to the control circuit board. The cover body covers and is disposed to another side of the housing to seal the LED light source. The LED light bulb structure comprises: the housing integrally formed and circularly disposed with a plurality of gutters at uniform intervals on an outer surface of the housing, the gutters taken as heat dissipation purpose, the housing circularly disposed with a mounting portion corresponding to the LED light source, the mounting portion inclined toward the housing and having an inclined angle relative to a horizontal plane to dispose the LED light source. The inclined angle is between 5 and 45 degrees, and an airflow hole is disposed in the middle of the housing and the mounting portion is located at the peripheral of the airflow hole.

In an embodiment, the LED light source is disposed in plural and a LED chip respectively, and the mounting portion is partitioned into a plurality of mounting regions corresponding to the LED light sources. The mounting regions are respectively located among the gutters.

Moreover, the base body is disposed with a plurality of screw holes, and the housing is disposed with a plurality of through holes corresponding to the screw holes to assemble the base body and the housing by screwing manner. A bottom of the cover body is disposed with a plurality of piercing holes for allowing air to enter and forming ventilation together with the gutters so as to exhaust heat energy generated by the LED light source.

In addition, to increase heat dissipation efficiency, the housing respectively has a partition portion corresponding to the gutters, thereby partitioning the gutters such that air can flow. The bottom of the cover body is circularly disposed with the plurality of piercing holes for allowing air to enter and forming ventilation together with the gutters so as to exhaust heat energy generated by the LED light source.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is an illumination diagram of a conventional LED light bulb;

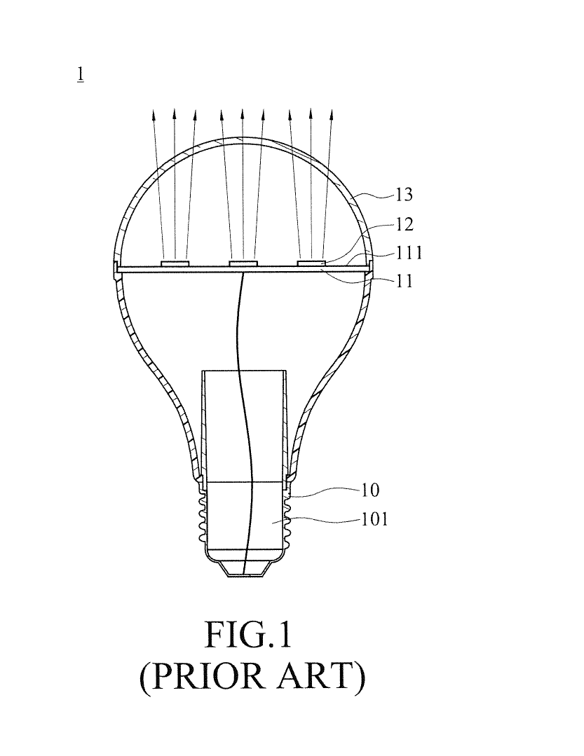

FIG. 2 is a three-dimensional decomposition drawing according to a first embodiment of the invention;

FIG. 3 is a cross-sectional drawing according to a first embodiment of the invention;

FIG. 4 is a three-dimensional decomposition drawing according to a first implementation pattern of a second embodiment of the invention;

FIG. 5 is an assembling diagram according to a first implementation pattern of a second embodiment of the invention;

FIG. 6 is an illumination diagram according to a first implementation pattern of a second embodiment of the invention;

FIG. 7 is a three-dimensional diagram according to a second implementation pattern of a second embodiment of the invention.

### DETAILED DESCRIPTION OF THE PREFERRED EMBODIMENTS

The technical content of the present invention will become apparent by the detailed description of the following embodiments and the illustration of related drawings as follows.

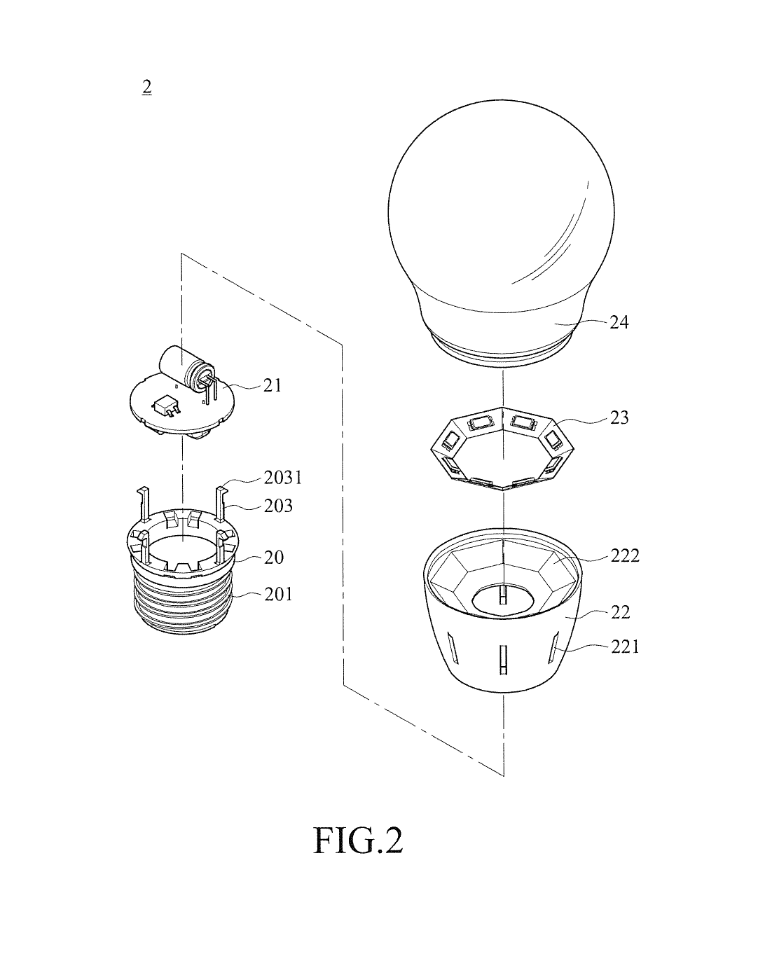

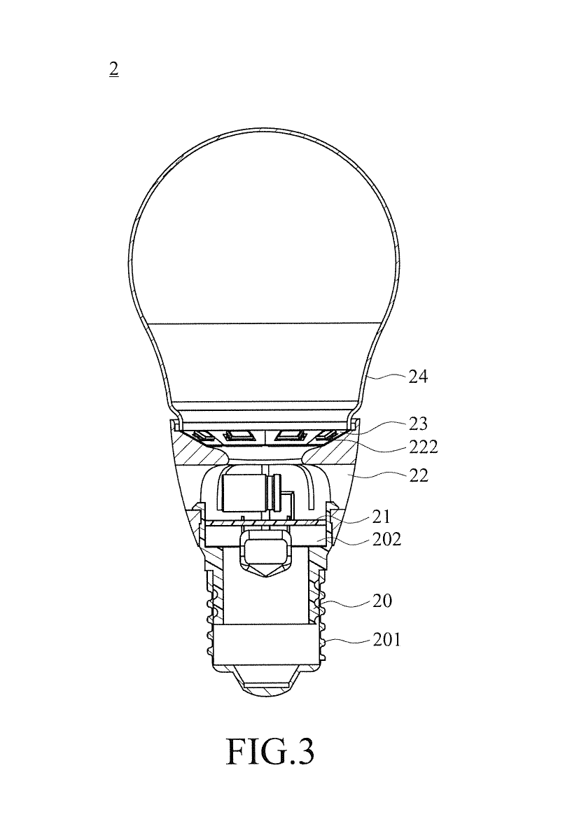

With reference to FIG. 2 and FIG. 3 for a three-dimensional decomposition drawing and a cross-sectional drawing according to a first embodiment of the invention are depicted. A LED light bulb structure 2 of the invention has a base body 20, a control circuit board 21, a housing 22, at least a LED light source 23 and a cover body 24. The base body 20 is disposed with an electrical connection portion 201 and connected and disposed to a side of the housing 22 to form a containing space 202 for disposing the control circuit board 21. The LED light source 23 is disposed to the housing 22 and electrically connected to the control circuit board 21. The cover body 24 covers and is disposed to another side of the housing 22 to seal the LED light source 23. The features of the invention are as the following.

The housing 22 is made of a material having heat dissipation function and is integrally formed and circularly disposed with a plurality of gutters 221 at uniform intervals on an outer surface of the housing to enhance heat dissipation effect of the LED light bulb structure 2. The housing 22 is circularly disposed with a mounting portion 222 for disposing the LED light source 23. Preferably, the mounting portion 222 is located a top of the housing 22, and the mounting portion 222 is inclined toward an inside of the housing 22 and has an inclined angle relative to a horizontal plane such that after the LED light source 23 is disposed to the mounting portion 222, emitted light beam having greater illumination angles is provided to a user with a larger illumination area, wherein the inclined angle is between 5 and 45 degrees.

An airflow hole 223 is disposed in the middle of the housing 22, and the mounting portion 222 is located at the peripheral of the airflow hole 223. The heat generated by the LED light source 23 can be effectively dissipated by the airflow hole 223 and the circulation of the air is produced to achieve the effect of thermal conductivity.

In the embodiment, the LED light source 23 is a soft LED light bar fastened to the mounting portion 222 by means of circular disposition. By comparing with a conventional LED lamp, the invention effectively simplifies the manufacture process and allows the light beam generated by the LED light bulb structure 2 to scatter toward everywhere by utilizing a encircling design.

The base body 20 is disposed with a plurality of convex posts 203 to respectively and correspondingly buckle the gutters 221 to assemble the base body 20 and the housing 22, wherein tops of the convex posts 203 are respectively disposed with an engagement portion 2031 to reinforce the engagement force between the base body 20 and the housing 22.

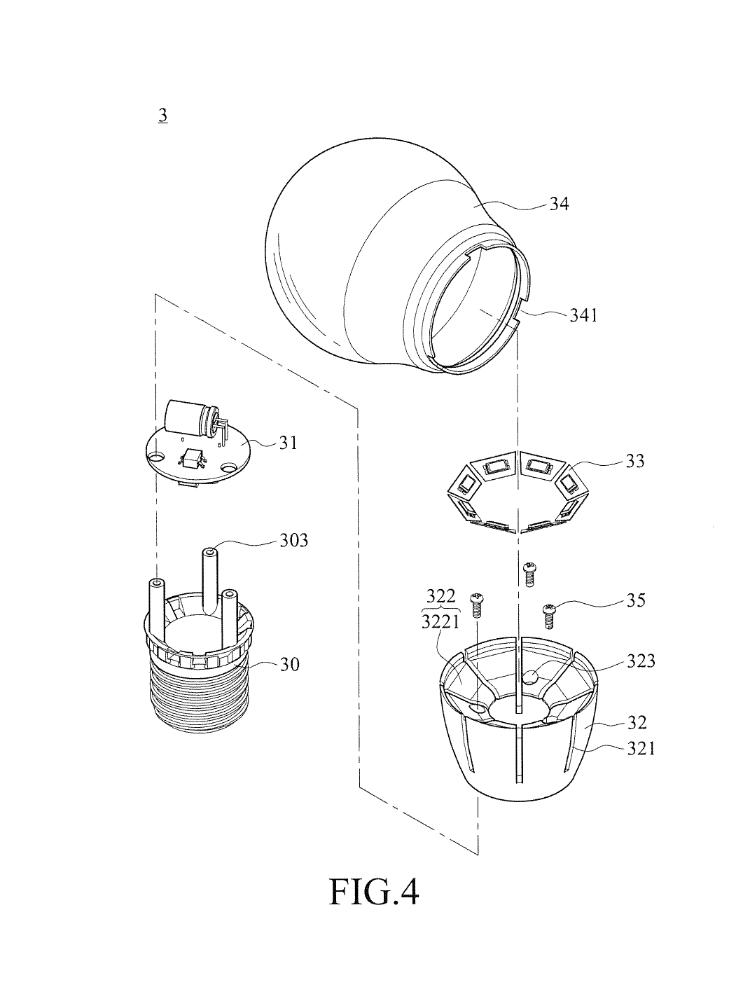

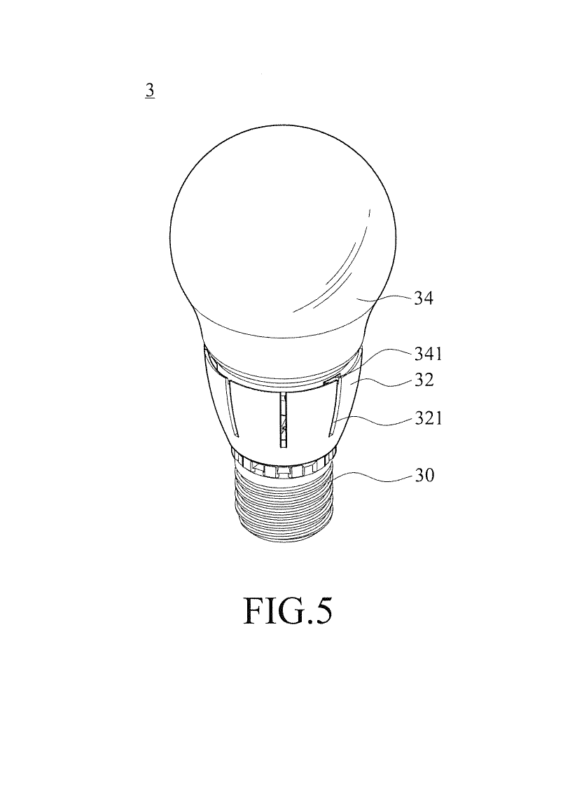

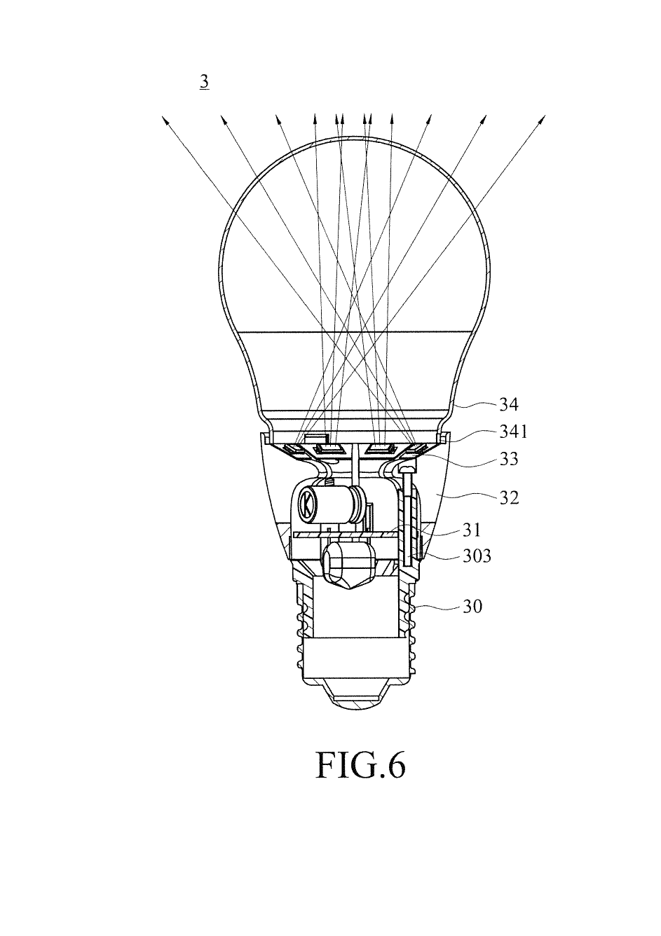

With reference to FIG. 4, FIG. 5 and FIG. 6 for a three-dimensional decomposition drawing, an assembling diagram and an applied illumination distribution diagram according to a first implementation pattern of a second embodiment of the invention are depicted. A LED light bulb structure 3 of the invention has a base body 30, a control circuit board 31, a housing 32, at least a LED light source 33 and a cover body 34. According to the first embodiment, the same portion is not depicted in detail. In this embodiment, the LED light sources 33 are disposed in plural. Each LED light source 33 is a chipset light emitting article. A mounting portion 322 corresponds to LED light sources 33 to separate a plurality of mounting regions 3221 for installing the LED light sources 33, wherein the mounting regions 3221 are respectively disposed among each gutter 321 such that heat generated by the LED light sources 33 can be smoothly exhausted to extend the service life of the LED light bulb structure 3.

As shown in FIG. 6, the divergent range of light beam of the LED light sources 33 is wider than a conventional LED lamp. The LED light sources 33 are chipset and can retain the brightness of the light bulbs without reducing the light beam intensity due to expanded illumination range.

In addition, in the embodiment, the base body 30 is disposed with a plurality of screw holes 303. The housing 32 is disposed with a plurality of through holes 323 corresponding to the screw holes 303. The base body 30 and the housing 32 are assembled since a plurality of fastening screws 35 respectively passes through the through holes 323 and is tightly locked in the screw holes 303.

Moreover, a bottom of the cover body 34 is circularly disposed with a plurality of piercing holes 341 such that after the cover body 34 is mounted to the housing 32, air can enter from the piercing holes 341 and forms ventilation by incorporating with the gutters 321. Accordingly, heat generated by the LED light sources can be effectively exhausted.

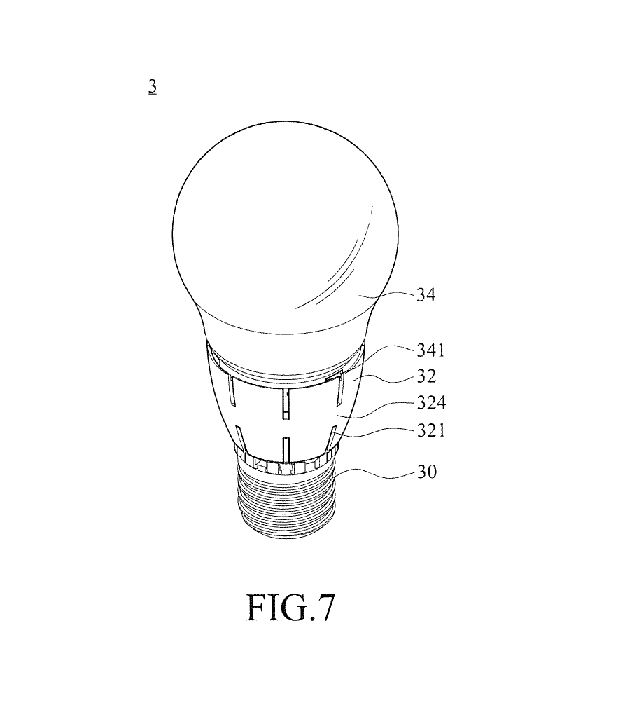

With reference to FIG. 7 for a three-dimensional drawing according to a second implementation pattern of a second embodiment is depicted. In the implementation pattern, the housing 32 respectively has a partition portion 324 corresponding to the gutters 321 to partition the gutters 321 to reinforce the ventilation effect so that the heat dissipation effect of the LED light bulb structure can be further improved.

The LED light bulb structures 2, 3 of the invention utilize the gutters 221, 321 on the housings 22, 32 to effectively exhaust heat energy. The mounting portions 222, 322 are inwardly inclined toward the housings 22, 32 to increase light divergence angle of the LED light sources 23, 33. The LED soft light bars or LED chips are taken as a light emitting source to retain a certain brightness of the LED light bulb structures 2, 3 and the illumination effect having greater range simultaneously. In addition, by incorporating designs of the piercing holes 341 and the partition portions 324, heat dissipation effect can be greatly improved to extend the service life of the LED light bulb structures 2, 3.

What is claimed is:

1. A LED light bulb structure having a base body, a control circuit board, a housing, at least a LED light source and a cover body, the base body disposed with an electrical connection portion and connected to a side of the housing to form a containing space for disposing the control circuit board, the LED light source disposed to the housing and electrically connected to the control circuit board, the cover body disposed to another side of the housing to seal the LED light source, the LED light bulb structure comprising:
the housing being integrally formed and circularly disposed with a plurality of gutters at uniform intervals on an outer surface of the housing, the gutters taken as heat dissipation purpose, the housing circularly disposed with a mounting portion corresponding to the LED light source, the mounting portion inclined toward the housing and having an inclined angle relative to a horizontal plane to dispose the LED light source.

2. The LED light bulb structure of claim 1, wherein the inclined angle is between 5 and 45 degrees.

3. The LED light bulb structure of claim 2, wherein the LED light source is a soft light bar fastened to the mounting portion by circular disposition.

4. The LED light bulb structure of claim 2 wherein a bottom of the cover body is disposed with a plurality of piercing holes for allowing air to enter and forming ventilation together with the gutters so as to exhaust heat energy generated by the LED light source, the housing respectively has a partition portion corresponding to the gutters, thereby partitioning the gutters.

5. The LED light bulb structure of claim 2, wherein the LED light source is disposed in plural and a LED chip respectively, and the mounting portion is partitioned into a plurality of mounting regions corresponding to the LED light sources, wherein each of the mounting regions are respectively located among each of the gutters.

6. The LED light bulb structure of claim 5 wherein a bottom of the cover body is disposed with a plurality of piercing holes for allowing air to enter and forming ventilation together with the gutters so as to exhaust heat energy generated by the LED light source, the housing respectively has a partition portion corresponding to the gutters, thereby partitioning the gutters.

7. The LED light bulb structure of claim 1, wherein an airflow hole is disposed in a middle of the housing, and the mounting portion is located at a peripheral of the airflow hole.

8. The LED light bulb structure of claim 1, wherein the base body is disposed with a plurality of screw holes, and the housing is disposed with a plurality of through holes corresponding to the screw holes to assemble the base body and the housing by screwing manner.

9. The LED light bulb structure of claim 8 wherein a bottom of the cover body is disposed with a plurality of piercing holes for allowing air to enter and forming ventilation together with the gutters so as to exhaust heat energy generated by the LED light source, the housing respectively has a partition portion corresponding to the gutters, thereby partitioning the gutters.
